(19) United States
(12) Patent Application Publication
(10) Pub. No.: US 2013/0334251 A1
(43) Pub. Date: Dec. 19, 2013

(54) DRINKING APPARATUS EQUIPPED WITH BEVERAGE SUPPLY FUNCTION

(71) Applicants: Fangzhen Zheng, Shunde Foshan (CN); Mianchun Huang, Shunde Foshan (CN); Duming Zeng, Shunde Foshan (CN); Richard Edward Belmont, Winston-Salem, NC (US)

(72) Inventors: Fangzhen Zheng, Shunde Foshan (CN); Mianchun Huang, Shunde Foshan (CN); Duming Zeng, Shunde Foshan (CN); Richard Edward Belmont, Winston-Salem, NC (US)

(73) Assignees: PRIMO WATER CORPORATION, WINSTON-SALEM, NC (US); MEDIA GROUP CO., LTD., SHUNDE FORSHAN, GUANGDONG (CN)

(21) Appl. No.: 14/002,606

(22) PCT Filed: Jul. 9, 2011
(86) PCT No.: PCT/CN2011/077017

§ 371 Date: Aug. 30, 2013

(30) Foreign Application Priority Data
Mar. 4, 2011 (CN) 201110052171.5

(51) Int. Cl. B67D 7/78

(52) U.S. Cl. CPC B67D 7/78
USPC 222/129.1

(57) ABSTRACT

A drinking apparatus equipped with beverage supply function includes a drinking machine, a beverage module and a control circuit. The drinking machine has an area at the top to hold the beverage module. The area has a first water passage connection port communicating with an internal water passage of the drinking machine and a first circuit connection port connecting to an internal circuit of the drinking machine. The beverage module has a second water passage connection port communicating with an internal water passage of the beverage module and a second circuit connection port connecting to an internal circuit of the beverage module. The first water passage connection port and first circuit connection port of the drinking machine are coupled respectively with the second water passage connection port and second circuit connection port of the beverage module. Water and power of the beverage module are provided by the drinking machine.

### FIELD OF THE INVENTION

The present invention relates to a drinking apparatus and particularly to a drinking apparatus equipped with beverage supply function.

### BACKGROUND OF THE INVENTION

Drinking water and beverages are indispensable to people's daily life. Every body wants to have sanitary and healthy drinks. At present, most drinking machines and beverage machines are independent and separate, and cannot meet people's requirement for using drinking water to directly brew various types of beverages. To overcome this disadvantage, multifunctional beverage and water drinking machines have been developed with a beverage module embedded in a drinking machine. References can be found in China patent Nos. CN2834380Y, CN201029772Y and CN201153868Y. They also disclose a dual purpose machine to supply beverages and drinking water. It mainly includes a brewing device inside a drinking machine. By combining the drinking machine and brewing device together, the drinking machine not only can provide cold and hot drinking water, also can supply the cold and hot drinking water to the brewing device to brew desired beverages, thereby achieves the dual functions of supplying beverages and drinking water. However, the aforesaid beverage module is fixedly embedded inside the drinking machine, and cannot be detached or replaced by other types of beverage modules. As a result, the used beverage module is difficult to wash and clean, and also cannot be changed to supply other types of beverages that might be required. In addition, with the beverage module installed inside the drinking machine, operation space is smaller, installation and repair and maintenance are also difficult. In the event that the beverage supply function is no longer needed, disassembly of the beverage module also is difficult.

### SUMMARY OF THE INVENTION

The primary object of the present invention is to solve the disadvantages of the conventional techniques by providing a drinking apparatus equipped with beverage supply function that can be incorporated with multiple types of beverage modules and installed quickly, and allows the beverage modules to be detached and replaced easily, and also is simpler in repair and maintenance.

To achieve the foregoing object, the drinking apparatus equipped with beverage supply function of this invention includes a drinking machine (1), a beverage module (2) and a control circuit. The drinking machine (1) has an area at the top to hold the beverage module (2). The area has a first water passage connection port (11) communicating with an internal water passage of the drinking machine (1) and a first circuit connection port (12) connecting to an internal circuit of the drinking machine (1). The beverage module (2) has a second water passage connection port (21) communicating with an internal water passage of the beverage module (2) and a second circuit connection port (22) connecting to an internal circuit of the beverage module (2). The first water passage connection port (11) and first circuit connection port (12) of the drinking machine (1) are connected respectively to the second water passage connection port (21) and second circuit connection port (22) of the beverage module (2). Water and electric power of the beverage module (2) are provided by the drinking machine (1).

The area at the top of the drinking machine (1) to hold the beverage module (2) is a recess (14) formed on a top lid (13) of the drinking machine (1).

The beverage module (2) is detachable from the drinking machine (1).

The drinking machine (1) also includes a water pump (3) connecting to the first water passage connection port (11) and the internal water passage of the drinking machine (1).

The first water passage connection port (11) of the drinking machine (1) is located on the top lid (13), and the first circuit connection port (12) is located at the bottom surface of the recess (14) on the top lid. The second water passage connection port (21) with an opening facing downward is located at the bottom of the beverage module (2) and mating and connecting to the first water passage connection port (11). The beverage module (2) further has a projection (23) mating the recess (14) on the top lid (13) and the second circuit connection port (22) mating the first circuit connection port (12).

The recess (14) has at least one guiding strut (15), and the projection (23) of the beverage module (2) has at least one guiding hole (24) mating and coupling with the guiding strut (15).

The first circuit connection port (12) of the drinking machine (1) is a lower connector, and the second circuit connection port (22) of the beverage module (2) is an upper connector that are coupled with each other to form electric connection.

The beverage module (2) provides functions of supplying various types of beverages, such as coffee, soda or juice, or provides a function of ice making.

The drinking apparatus of the invention thus formed provides standard water passage connection port and circuit connection port on the drinking machine and the mating water passage connection port and circuit connection port of the beverage module. When the beverage module is placed upright onto the top of the drinking machine, the corresponding water passage connection ports and circuit connection ports are connected to each other so that the beverage module and drinking machine can be coupled together. The beverage module directly gets water and electric power from the drinking machine, thus operation is simpler and easier. Through the guiding strut and guiding hole, assembly and installation is simpler and easier. The beverage module can be detached whenever it is desired for cleaning. Such a structure does not affect internal structures of the drinking machine and beverage module. By merely providing standard water passage connection ports and circuit connection ports, standardization can be achieved and the drinking machine can be coupled with different beverage modules with varying functions and models. Therefore the resulting products are more diversified. The structure is simpler and more reliable, and is easy to assemble and install. Moreover, as the drinking machine and beverage module are coupled together, installation space can be reduced. In the event that the beverage module malfunctions, repair and maintenance also is simpler.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a front view of an embodiment of the structure of the invention.

FIG. 2 is a perspective view of an embodiment of the drinking machine of the invention.

FIG. 3 is a bottom view of an embodiment of the beverage module of the invention.

FIG. 4 is a sectional view of an embodiment of the invention.

Unessential elements of the invention have been omitted in the drawings.

### DETAILED DESCRIPTION OF THE PREFERRED EMBODIMENT

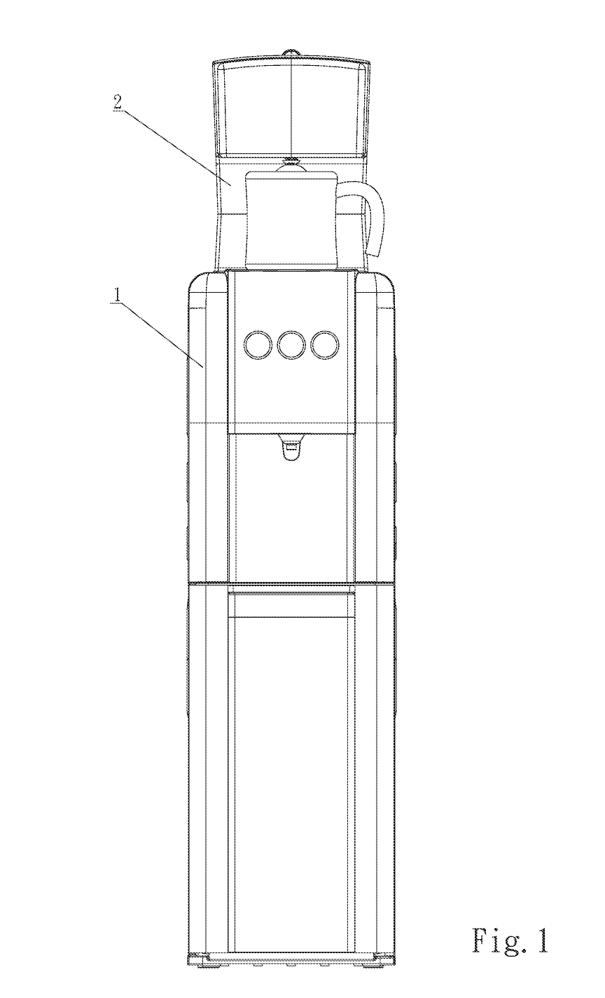

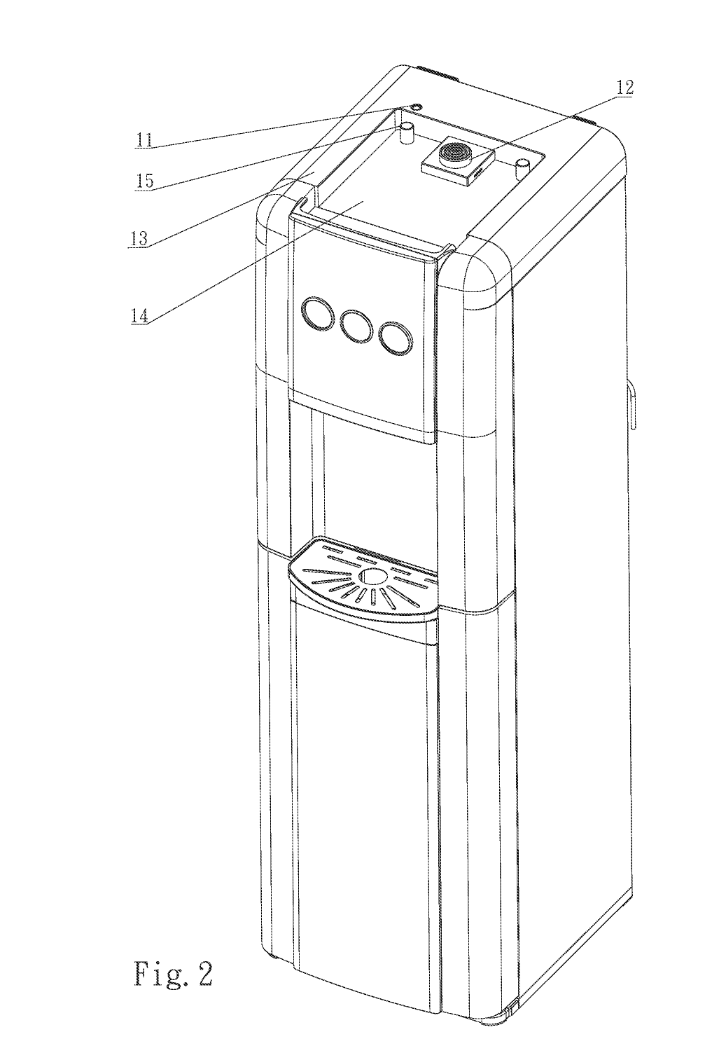

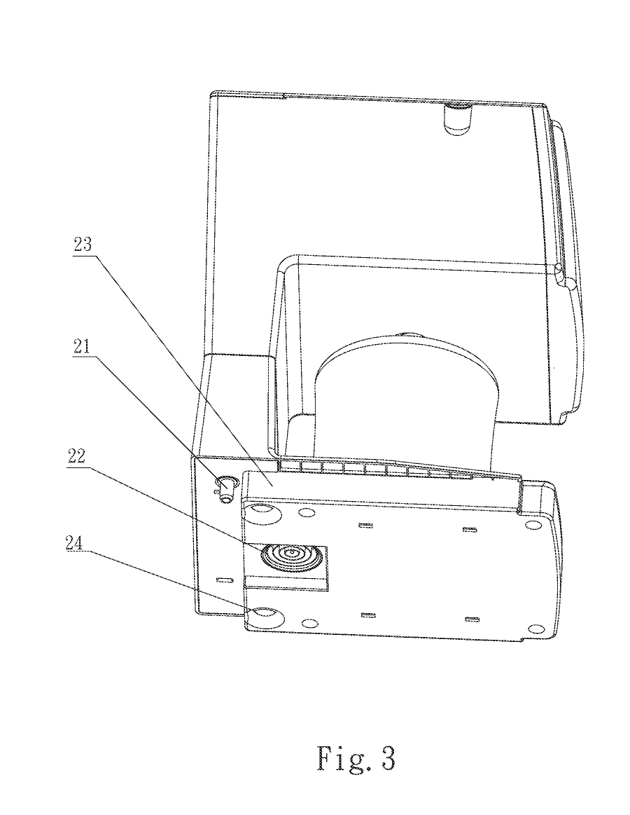

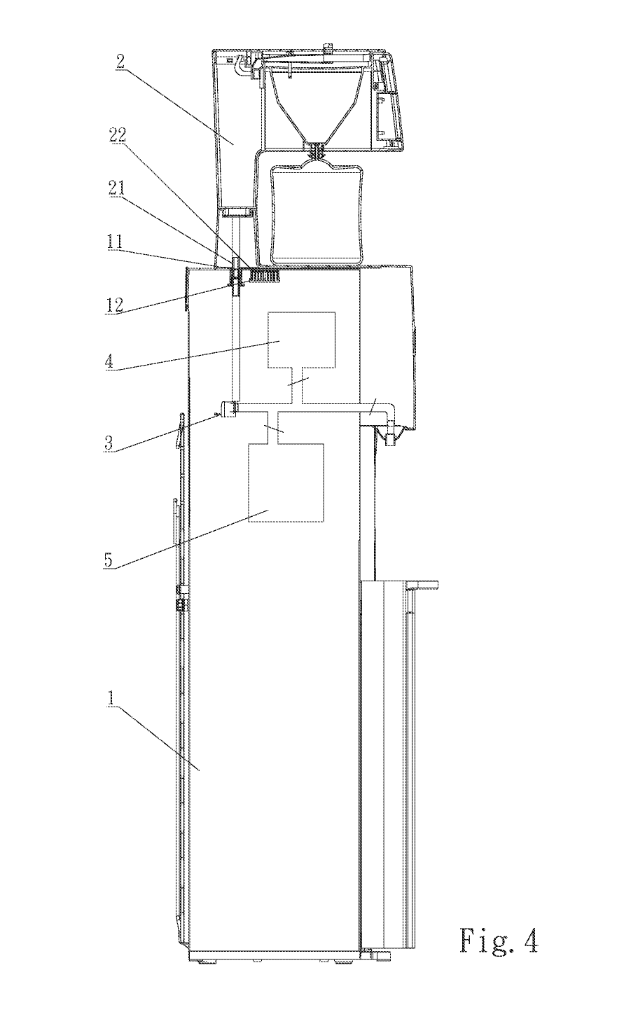

Please refer to FIG. 1, the present invention is a drinking apparatus equipped with beverage supply function. It includes a drinking machine 1, a beverage module 2 and a control circuit. The drinking machine 1 has an area at the top thereof to hold the beverage module 2. The area has a first water passage connection port 11 communicating with an internal water passage of the drinking machine 1 and a first circuit connection port 12 connecting to an internal circuit of the drinking machine 1 as shown in FIG. 2. The beverage module 2 has a second water passage connection port 21 communicating with an internal water passage of the beverage module 2 and a second circuit connection port 22 connecting to an internal circuit of the beverage module 2 as shown in FIG. 3. The first water passage connection port 11 and first circuit connection port 12 of the drinking machine 1 are connected respectively to the second water passage connection port 21 and second circuit connection port 22 of the beverage module 2. The water and electric power of the beverage module 2 are provided by the drinking machine 1 as shown in FIG. 4.

The area at the top of the drinking machine 1 to hold the beverage module 2 is a recess 14 formed on a top lid 13 of the drinking machine 1 as shown in FIG. 2.

The beverage module 2 is detachable from the drinking machine 1.

The drinking machine 1 also includes a water pump connecting to the first water passage connection port 11 and internal water passage of the drinking machine 1 as shown in FIG. 4.

Referring to FIGS. 3 and 4, the first water passage connection port 11 of the drinking machine 1 is located on the top lid 13, and the first circuit connection port 12 is located on the bottom surface of the recess 14 on the top lid 13. The second water passage connection port 21 with an opening facing downward is located at the bottom of the beverage module 2 and mating and connecting to the first water passage connection port 11. The beverage module 2 further has a projection 23 mating the recess 14 on the top lid 13 and the second circuit connection port 22 mating the first circuit connection port 12.

The recess 14 has one or two guiding struts 15, and the projection 23 of the beverage module 2 has a guiding hole 24 mating the guiding strut 15.

The first circuit connection port 12 of the drinking machine 1 is a lower connector, and the second circuit connection port 22 of the beverage module 2 is an upper connector that are coupled with each other to form electric connection.

The beverage module 2 provides functions of supplying various types of beverages, such as coffee, soda or juice, or provides a function of ice making.

The drinking apparatus thus formed provides dual functions of supplying beverages and drinking water. The beverage module 2 directly gets water and electric power from the drinking machine 1, i.e., when the beverage module 2 is in use, electric power is supplied by the drinking machine 1. Water needed to brew beverage is pumped via the water pump 3 from a cold water keg 4 or a hot water keg 5 of the drinking machine 1 and delivered to the beverage module 2 as shown in FIG. 4.

The invention thus formed can meet requirement of supplying multiple types of beverages through only one set of drinking machine. The coupling assembly is easier for installation and operation, and also simpler to change the beverage module for other types of beverages. The beverage module also can be detached whenever it is desired for cleaning or repairing and maintaining. The structure does not affect the internal structures of the drinking machine and beverage module. By merely providing the water passage connection ports and circuit connection ports, standardization can be achieved. The drinking machine also can be incorporated with different beverage modules with varying functions and models to become more diversified. In short, the structure is simpler and more reliable, and easier to assemble and install. Moreover, as the drinking machine and beverage module are installed and coupled together, occupied space can be reduced, thus usability improves.

1. A drinking apparatus equipped with beverage supply function comprising a drinking machine (1), a beverage module (2) and a control circuit;
wherein the drinking machine (1) includes an area at the top thereof to hold the beverage module (2), the area including a first water passage connection port (11) communicating with an internal water passage of the drinking machine (1) and a first circuit connection port (12) connecting to an internal circuit of the drinking machine (1);
wherein the beverage module (2) includes a second water passage connection port (21) communicating with an internal water passage of the beverage module (2) and a second circuit connection port (22) connecting to an internal circuit of the beverage module (2); and
wherein the first water passage connection port (11) and the first circuit connection port (12) of the drinking machine (1) are coupled respectively with the second water passage connection port (21) and the second circuit connection port (22) of the beverage module (2), water and electric power of the beverage module (2) being provided by the drinking machine (1).

2. The drinking apparatus of claim 1, wherein the area at the top of the drinking machine (1) to hold the beverage module (2) is a recess (14) formed on a top lid (13) of the drinking machine (1).

3. The drinking apparatus of claim 1, wherein the beverage module (2) is detachable from the drinking machine (1).

4. The drinking apparatus of claim 3, wherein the drinking machine (1) further includes a water pump (3) connecting to the first water passage connection port (11) and the internal water passage of the drinking machine (1).

5. The drinking apparatus of claim 2, wherein the first water passage connection port (11) is located on the top lid (13), the first circuit connection port (12) being located on the bottom surface of the recess (14), the second water passage connection port (21) with an opening facing downward being located on the bottom of the beverage module (2) and mating and connecting to the first water passage connection port (11), the beverage module (2) including a projection (23) mating the recess (14) and the second circuit connection port (22) mating the first circuit connection port (12).

6. The drinking apparatus of claim 5, wherein the recess (14) includes a guiding strut (15), the beverage module (2) including a guiding hole (24) located on the projection (23) and mating and coupling with the guiding strut (15).

7. The drinking apparatus of claim 6, wherein the first circuit connection port (12) is a lower connector and the second circuit connection port (22) is an upper connector that are connected with each other to form electric connection.

8. The drinking apparatus of claim 1, wherein the beverage module (2) selectively provides functions of coffee supply, ice making, soda supply or juice supply.
